(19) United States
(12) Patent Application Publication
(10) Pub. No.: US 2023/0357564 A1
(43) Pub. Date: Nov. 9, 2023

(54) COMPOSITE FOR MANUFACTURING BARRIER LAYER, BARRIER LAYER, METHOD FOR MANUFACTURING BARRIER LAYER, AND PACKAGING MATERIAL

(71) Applicant: ShenZhen YUTO Packaging Technology Co., Ltd., Shenzhen (CN)

(72) Inventors: Zhengyang MU, Shenzhen (CN); Zhangyan CHEN, Shenzhen (CN); Guocheng HAN, Shenzhen (CN); Yanfei CHENG, Shenzhen (CN); Wenxiu LI, Shenzhen (CN); Wei HE, Shenzhen (CN); Mengyao LI, Shenzhen (CN)

(73) Assignee: ShenZhen YUTO Packaging Technology Co., Ltd., Shenzhen, GD (CN)

(21) Appl. No.: 17/991,835

(22) Filed: Nov. 21, 2022

(30) Foreign Application Priority Data
May 7, 2022 (CN) 202210493283.2

(51) Int. Cl. C08L 67/04; B29C 70/58; B29C 70/00

(52) U.S. Cl. CPC C08L 67/04; B29C 70/58; B29C 70/003; B29L 2031/712

(57) ABSTRACT

A composite for manufacturing a barrier layer, a barrier layer, a method for manufacturing the barrier layer, and a packaging material are provided. Based on the total mass of the composite as 100 parts by mass, the composite includes the following components by mass: Polyhydroxyalkanoate, 70 to 96 parts by mass; polylactic acid, 1 to 15 parts by mass; modified layered silicate, 1 to 5 parts by mass; polyalkylene carbonate, 1 to 20 parts by mass; and auxiliary agent, 1.3 to 12 parts by mass.

### CROSS-REFERENCE TO RELATED APPLICATION

This application is filed based upon and claims priority to Chinese patent application No. 202210493283.2, filed on May 7, 2022, the entire content of which is incorporated herein by reference for all purposes.

### TECHNICAL FIELD

The present application relates to the technical field of packaging materials, in particular to a composite for manufacturing a barrier layer, a barrier layer, a method for manufacturing the same, and a packaging material.

### BACKGROUND

With the rapid economic development and the improvement of people's quality of life, the demand for daily necessities such as food and cosmetics is also increasing, which will directly promote the demand for related product packaging.

However, in the related art, some fluids can permeate the packaging material in a large amount and come into contact with the product in the packaging material, resulting in a rapid deterioration of the quality of the product.

### SUMMARY

The present disclosure provides a composite for manufacturing a barrier layer, a method for manufacturing the barrier layer, and a packaging material, and the composite can improve the barrier properties of the barrier layer to reduce fluid penetration.

According to a first aspect of the present disclosure, a composite for manufacturing a barrier layer is provided. The composite, based on the total mass of the composite as 100 parts by mass, includes the following ingredients in parts by mass: Polyhydroxyalkanoate, 70 parts by mass to 96 parts by mass; polylactic acid, 1 to 15 parts by mass; modified layered silicate, 1 to 5 parts by mass; polyalkylene carbonate, 1 part by mass to 20 parts by mass; and auxiliary agent, 1.3 parts by mass to 12 parts by mass.

According to a second aspect of the present disclosure, a barrier layer manufactured using a composite according to the first aspect is provided.

According to a third aspect of the present disclosure, a method for manufacturing a barrier layer is provided. The manufacturing method includes: blending and granulating Polyhydroxyalkanoate, polylactic acid, modified layered silicate, polyalkylene carbonate and auxiliary agent to obtain granulated product; and the granulated product is molded to obtain the barrier layer by extrusion or injection.

According to a fourth aspect of the present disclosure, a packaging material is provided. The packaging material may include a substrate and a barrier layer according to the second as aspect. Furthermore, the barrier layer is disposed of on at least one surface of the substrate.

### BRIEF DESCRIPTION OF THE DRAWINGS

In order to illustrate the technical solutions in the examples of the present disclosure more clearly, the following briefly introduces the accompanying drawings used in the description of the examples. Obviously, the accompanying drawings in the following description are some examples of the present disclosure. For those of ordinary skill in the art, other drawings can also be obtained from these drawings without creative effort.

FIG. 1 is a schematic structural diagram of the packaging material provided in Example 1 of the present disclosure.

FIG. 2 is a schematic structural diagram of the packaging material provided in Example 2 of the present disclosure.

FIG. 3 is a schematic structural diagram of the packaging material provided in Example 3 of the present disclosure.

### DETAILED DESCRIPTION

Each example or implementation in this specification is described in a progressive scheme, and each example focuses on the differences from other examples.

Unless otherwise defined, all technical and scientific terms used herein have the same meaning as commonly understood by one of ordinary skill in the technical field of this application; the terms used herein are for the purpose of describing specific examples only and are not intended to be limiting this application; the terms “comprising” and “having” and any variations thereof in the description and claims of this application are intended to cover non-exclusive inclusion.

In the description of this application, technical terms such as “first” and “second” are only used to distinguish different objects and should not be understood as indicating or implying relative importance or implying the number, specific order, number of technical features indicated, or primary relationship. In the description of this application, “plurality” means two or more, unless otherwise expressly and specifically defined.

In the description of this specification, reference to the description of the terms “one embodiment,” “some embodiments,” “exemplary embodiment,” “exemplary,” “specific example,” or “some examples,” etc., is meant to incorporate a particular feature, structure, material, or characteristic described by an embodiment or an example included in at least one embodiment or example of the present disclosure. In this specification, schematic representations of the above terms do not necessarily refer to the same embodiment or example. Furthermore, the particular features, structures, materials or characteristics described may be combined in suitable arrangements in any one or more embodiments or examples.

The present disclosure provides a composite for manufacturing a barrier layer, calculated based on a total mass of the composite as 100 parts by mass, including the following ingredients in parts by mass: Polyhydroxyalkanoate, 70 to 96 parts by mass; polylactic acid, 1 to 15 parts by mass; modified layered silicate, 1 to 5 parts by mass; polyalkylene carbonate, 1 to 20 parts by mass; and auxiliary agent, 1.3 to 12 parts by mass.

In the present disclosure, Polyhydroxyalkanoate may be used as the main component, and other components and their contents may be reasonably matched. In the manufacturing process of the barrier properties, the other components may modify the Polyhydroxyalkanoate, so that the barrier layer obtained has good barrier properties, which may reduce the penetration of fluids and delay the decline of product quality.

In the examples of the present disclosure, Polyhydroxyalkanoate, as an intracellular polyester, is not only biodegradable, but also has good barrier properties. Therefore, in the examples of the present disclosure, based on the total mass of the composite as 100 parts by mass, the parts by mass of the Polyhydroxyalkanoate are 70 parts by mass to 96 parts by mass. These part numbers are only used for an example, but not limited to these particular numbers.

In some examples, the mass parts of Polyhydroxyalkanoate may be, but not limited to, 70 parts by mass, 71 parts by mass, 72 parts by mass, 73 parts by mass, 74 parts by mass, 75 parts by mass, 76 parts by mass, 77 parts by mass, 78 parts by mass parts by mass, 79 parts by mass, 80 parts by mass, 81 parts by mass, 82 parts by mass, 83 parts by mass, 84 parts by mass, 85 parts by mass, 86 parts by mass, 87 parts by mass, 88 parts by mass, 89 parts by mass, 90 parts by mass, 91 parts by mass, 92 parts by mass, 93 parts by mass, 94 parts by mass, 95 parts by mass, or 96 parts by mass.

In some examples of the present disclosure, the Polyhydroxyalkanoate may be selected from the copolymers of 3-hydroxybutyric acid and 3-hydroxyhexanoic acid, and the copolymers of 3-hydroxybutyric acid and 3-hydroxyhexanoic acid may also be referred to as poly-3-Hydroxybutyrate-co-3-hydroxycaproate (PHBH). PHBH has good barrier properties and is biodegradable. Modification of it by other components can further improve the barrier properties of the barrier layer.

In some examples of the present disclosure, the average molecular weight of the copolymer of 3-hydroxybutyric acid and 3-hydroxyhexanoic acid is 50,000-200,000. The average molecular weight of the above-mentioned copolymer is within the above-mentioned range, which can not only improve its barrier properties, but also improve its thermal processing properties and mechanical properties, such as tensile strength and elongation at break, etc.

In addition, in some examples of the present disclosure, the mass content of 3-hydroxyhexanoic acid in the copolymer of 3-hydroxybutyric acid and 3-hydroxyhexanoic acid may be 6%-11%. When the mass content of 3-hydroxycaproic acid is within the above range, it can further improve its thermal processing properties and mechanical properties (such as tensile strength and elongation at break, etc.) while improving its own barrier properties.

In some examples of the present disclosure, the polyhydroxyalkanoate may also be selected from poly-3-hydroxybutyrate (PHB), poly-3-hydroxyhexanoate, poly-3-hydroxyvalerate, poly-3-Hydroxybutyrate-co-3-hydroxyvalerate (PHBV), and any combination thereof.

In the examples of the present disclosure, the addition of polylactic acid (PLA) can improve the thermal processability and mechanical properties (e.g., hardness, stiffness) of the Polyhydroxyalkanoate, so as to facilitate the manufacture of the desired packaging material. Therefore, the mass fraction of polylactic acid is 1 part by mass to 15 parts by mass.

In some examples, the mass parts of polylactic acid may be, but not limited to, 1 part by mass, 2 parts by mass, 3 parts by mass, 4 parts by mass, 5 parts by mass, 6 parts by mass, 7 parts by mass, 8 parts by mass, 9 parts by mass, 10 parts by mass, 11 parts by mass, 12 parts by mass, 13 parts by mass, 14 parts by mass, or 15 parts by mass.

In some examples of the present disclosure, the polylactic acid may have an average molecular weight of 100,000-300,000. When the average molecular weight of the polylactic acid is within the above range, the thermal processability and mechanical properties of the Polyhydroxyalkanoate can be further improved.

In the examples of the present disclosure, the modified layered silicate can improve the barrier properties of the Polyhydroxyalkanoate, which can further improve the barrier properties of the barrier layer. Therefore, the mass fraction of the modified layered silicate may be 1 to 5 parts by mass.

In some examples, the mass fraction of the modified layered silicate may be, but not limited to, 1 part by mass, 2 parts by mass, 3 parts by mass, 4 parts by mass, or 5 parts by mass.

In some examples of the present disclosure, the modified layered silicate may be an organically modified layered silicate, and the average interlayer distance of the organically modified layered silicate on the (001) plane is equal to or greater than 3 nm, so that the layered silicate can be peeled off and quickly dissolved into the Polyhydroxyalkanoate, thereby improving the barrier properties of the Polyhydroxyalkanoate. The (001) plane may represent a plane that passing through the origin x=0, y=0, and z=0 and the point x=0, y=0, and z=1 in a coordinate system on a unit cell of a crystal, where the coordinate system includes a plurality of coordinates (x, y, z) of crystal direction vectors.

In some examples of the present disclosure, the layered silicate may be montmorillonite, and the montmorillonite is organically modified using organic compounds well known in the art, such as double long chain alkyl ammonium compounds.

In the examples of the present disclosure, the polyalkylene carbonate can also improve the barrier properties of the Polyhydroxyalkanoate, which can further improve the barrier properties of the barrier layer. Therefore, the parts by mass of the polyalkylene carbonate may be 5 parts by mass to 20 parts by mass.

In some examples, the mass fraction of polyalkylene carbonate may be, but not limited to, 1 part by mass, 2 parts by mass, 3 parts by mass, 4 parts by mass, 5 parts by mass, 6 parts by mass, 7 parts by mass, 8 parts by mass, 9 parts by mass, 10 parts by mass, 11 parts by mass, 12 parts by mass, 13 parts by mass, 14 parts by mass, 15 parts by mass, 16 parts by mass, 17 parts by mass, 18 parts by mass, 19 parts by mass, or 20 parts by mass.

In some examples of the present disclosure, the polyalkylene carbonate is selected from end-capped polypropylene carbonates (PPCs), and the average molecular weight of the polypropylene carbonate is 30,000-100,000. On one hand, end-capped polypropylene carbonate can not only make it have better thermal processing properties, but also can improve the barrier properties of Polyhydroxyalkanoates. On the other hand, when the average molecular weight of polypropylene carbonate is in the above range, it can also improve its own thermal processing performance and improve the barrier performance of Polyhydroxyalkanoate.

In some examples of the present disclosure, based on the total mass of the auxiliary agent, the auxiliary agent may include the following components in parts by mass: inorganic nucleating agent, 1 to 5 parts by mass; organic nucleating agent, 0.1 to 2 parts by mass; compatibilizer, 0.1 to 2 parts by mass; and lubricant, 0.1 to 3 parts by mass.

In some examples of the present disclosure, the inorganic nucleating agent may be talc powder, the average particle size D₅₀ of the talc powder may be 0.5 μm-1.5 μm, and the average particle size D₉₈ of the talc powder may be less than or equal to 6 The particle size distribution of the talc powder is within the above-mentioned range, which can help the crystallization of the Polyhydroxyalkanoate, which can further improve its barrier properties.

Further, in the talc powder, the mass content of silicon dioxide may be greater than or equal to 60%, and the mass content of magnesium oxide may be 30%-35%.

In some examples of the present disclosure, the surface of the talc powder can also be modified to further improve the barrier properties of the Polyhydroxyalkanoate. The surface modification of talc can be any surface modification known to those skilled in the art, such as silane coupling agent modified ultrafine talc.

In some examples of the present disclosure, the organic nucleating agent and the inorganic nucleating agent act synergistically to further promote the crystallization of the Polyhydroxyalkanoate. The organic nucleating agent may be selected from at least one of hydroxyapatite, sodium lignosulfonate, zinc phenylphosphonate, aromatic sulfonate derivatives, rare earth β-crystal nucleating agents, aramid β-crystal nucleating agents, sebacic acid dibenzoyl hydrazide, or polyamide compounds.

In some examples of the present disclosure, the compatibilizer may be selected from at least one of ethylene-methyl acrylate-glycidyl methacrylate terpolymer, hexamethylene diisocyanate, diphenylmethane diisocyanate, 2,4-Toluene diisocyanate, 2,2-bis(2-oxazoline), 1,3-phenyl-bis(2-oxazoline), dicumyl peroxide, epoxy chain extender, or styrene-Maleic anhydride random copolymer.

In some examples of the present disclosure, the lubricant may be selected from a group consisting of at least one of acetylated mono-diglycerol fatty acid ester, ethylene bis-stearic acid amide, pentaerythritol stearate, erucic acid amide, oleic acid amide, stearic acid, polyethylene wax, zinc stearate, and ethylene acrylic acid copolymer.

The present disclosure provides a barrier layer manufactured using the composite as described by any of the above examples.

In some examples of the present disclosure, the water vapor transmission rate of the barrier layer may be 0.9 g/m²·day to 4.3 g/m²·day.

The present disclosure also provides a manufacturing method of a barrier layer, the manufacturing method including:
S10: blend and granulate Polyhydroxyalkanoate, polylactic acid, modified layered silicate, polyalkylene carbonate and auxiliary agent to obtain a granulated product;
S20: mold the granulated product by injection or extrusion to obtain the barrier layer.

In some examples of the present application, step S10 may specifically include:
S11: dry Polyhydroxyalkanoate and polylactic acid at 50° C.-80° C. for 4-8 hours (h), and dry polyalkylene carbonate at −10° C.-0° C. for 4-10 h;
S12: under stirring conditions, mix the above-mentioned dried Polyhydroxyalkanoate, polylactic acid and polyalkylene carbonate, and sequentially add inorganic nucleating agent, modified layered silicate, lubricant, organic nucleating agent and the compatibilizer; stir the mixture at a low speed for 3-15 minutes (min), and then stir the mixture at a high speed for 10-20 min to obtain a blend;
S13: extrude and granulate the blend to obtain a granulated product.

In step S13, the blend may be added to a twin-screw extruder for extrusion granulation, and after drying, a granulated product is obtained, where the extrusion processing temperature may be 90° C.-160° C., and the screw speed may be 100 rpm/min-350 rpm/min, the screw length-diameter ratio may be 40-56, the drying temperature may be 50° C.-80° C., and the drying time may be 4-10 h.

In some examples of the present disclosure, step S20 may specifically include:
S21: add the granulated product to a screw extrusion sheet machine for extrusion molding to obtain a first barrier layer, where the extrusion molding temperature may be 100° C.-150° C., and the screw aspect ratio may be 18-46.

In other examples of the present disclosure, step S20 may specifically include:
S22: add the granulated product to an injection molding machine and perform injection molding to obtain a second barrier layer, where the injection molding temperature may be 120° C.-150° C., the screw length-diameter ratio may be 17-22, and the screw compression ratio may be (2-3.5):1.

Moreover, the present disclosure provides a packaging material, including a substrate and the barrier layer described in any of the above examples. The barrier layer may be disposed of on at least one surface of the substrate.

In some examples of the present disclosure, the packaging material may be a packaging box for food and cosmetics, and the packaging box may include a box body and a cover body covered on the box body, and a barrier layer is arranged on the surface of the box body and the cover body. It can be understood that the box body and the cover body may be the base materials of the packaging material, and the base material can be made of natural plant fibers, so that the packaging material can be biodegraded, thereby achieving green environmental protection.

In some examples of the present disclosure, the barrier layer may be disposed on an outer surface of the substrate, where the barrier layer may be obtained through an extrusion molding process and may be adhered to the outer surface of the substrate through blister molding and thermoforming, with the temperature of plastic forming being 130° C.-160° C.

In some examples of the present disclosure, the barrier layer may be disposed on an inner surface of the substrate, where the barrier layer may be obtained through an injection molding process and may be adhered to the inner surface of the substrate through blow molding or thermocompression molding, and the temperature of blow molding may be 130° C.-160° C.

In addition, in some examples of the present disclosure, the box body and the cover body as the base material may be subjected to heat sealing treatment to form a semi-finished package box, where the temperature of the heat-sealing treatment may be 130° C.-160° C.

Further, the barrier layer of the semi-finished packaging box may be subjected to secondary crystallization treatment to obtain the finished packaging box, where the temperature of the secondary crystallization may be 50° C.-90° C., and the time of the secondary crystallization may be 5 min-10 min.

The manufacturing method of the packaging material will be described in detail below through specific examples.

### Example 1

The present example provides a method for manufacturing a packaging box including:
(1) dry PHBH at 50° C. for 4 h, dry PLA at 80° C. for 4 h, and dry PPC at 0° C. for 4 h;
(2) put 76.3 parts by mass of dried PHBH, 10 parts by mass of PLA, and 5 parts by mass of PPC into a mixer, stir at a low speed, and while stirring, add 3 parts by mass of talc, 3 parts by mass of modified montmorillonite, 0.5 part by mass of ethylene bisstearic acid amide, 0.8 part by mass of stearic acid, 0.3 part by mass of polyethylene wax, 0.8 part by mass of sodium lignosulfonate, and 0.3 part by mass of hexamethylene diisocyanate in turn, stir the mixture at low speed for 3 min, and then stir the mixture at high speed for 10 min to obtain a blend;
(3) add the blend to a twin-screw extruder for extrusion and granulation, and dry it at 70° C. for 6 hours to obtain a granulated product, where the extrusion processing temperature of the twin-screw extruder may be 90° C.-160° C., the screw speed may be 350 rpm/min, and the screw length-diameter ratio may be 40;
(4) add the granulated material into the screw extrusion sheet machine and extrude the sheet to obtain the first barrier layer, where the extrusion molding temperature may be 100° C.-150° C., and the screw length-diameter ratio may be 20;
(5) blister mold the first barrier layer at 130° C.-160° C. so that it is adsorbed on the inner surface of the pulp molding substrate to obtain the box body of the packaging box; the first barrier layer is subjected to slitting treatment, the first barrier layer after slitting is hot-pressed at 130° C.-160° C. to make it adsorb the surface of the pulp molding semi-finished pulp board to obtain a cover; the above box body and cover are carried out under the condition of 130° C.-160° C. heat-sealing to obtain a semi-finished packaging box;
(6) move the above-mentioned semi-finished packaging box into the crystallizer and perform secondary crystallization treatment on the first barrier layer of the packaging box to obtain a finished packaging box, where the temperature of the secondary crystallization may be 80° C., and the time of the secondary crystallization may be 5 min.

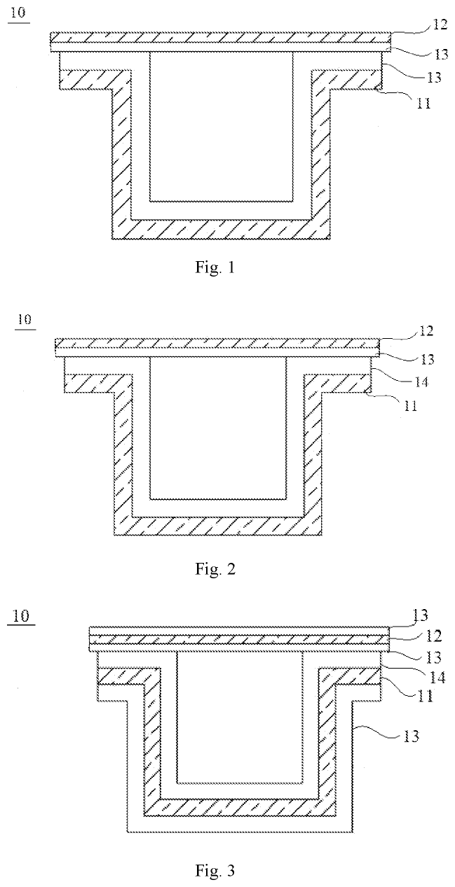

FIG. 1 is a cross-sectional view of the packaging box 10l provided in this example. The inner surface of the box body 11 and the surface of the cover body 12 facing the box body 11 are both adsorbed with a first barrier layer 13.

### Example 2

The present example provides a method for manufacturing a packaging box, including:
(1) dry PHBH at 70° C. for 6 h, dry PLA at 80° C. for 5 h, and dry PPC at −5° C. for 4 h;
(2) put 75.8 parts by mass of dried PHBH, 5 parts by mass of PLA, and 10 parts by mass of PPC into a mixer, stir at a low speed, and while stirring, add 4 parts by mass of talc and 3 parts by mass of modified montmorillonite, 0.6 part by mass of acetylated mono-diglyceride fatty acid ester, 0.5 part by mass of ethylene bis-stearic acid amide, 0.3 part by mass of ethylene acrylic acid copolymer, 0.5 part by mass of zinc phenylphosphonate, and 0.3 part by mass of epoxy chain extender in turn, where the mixture may be stirred at a low speed for 8 min, and then at a high speed for 15 min to obtain a blend;
(3) add the blend to a twin-screw extruder for extrusion and granulation, and dry it at 60° C. for 7 hours to obtain a granulated product, where the extrusion processing temperature of the twin-screw extruder may be 90° C.-160° C., the screw speed may be 250 rpm/min, and the screw length-diameter ratio may be 48;
(4) add the granulated product to a screw extruding sheet machine, and the first barrier layer is obtained by sheet extrusion molding, where the extrusion molding temperature may be 100° C.-150° C., and the screw length-diameter ratio may be 28;
(5) add the granulated product to an injection molding machine for injection molding to obtain a second barrier layer, where the injection molding temperature may be 120° C.-150° C., the screw length-diameter ratio may be 18, and the screw compression ratio may be 2.5;
(6) blister mold the second barrier layer at 130° C.-160° C. so that it is adhered to the inner surface of the pulp molding substrate to obtain the box body of the packaging box; the second barrier layer is subjected to slitting treatment, the second barrier layer after slitting is hot-pressed at 130° C.-160° C. to make it adhere to the surface of the pulp molding semi-finished pulp board to obtain a cover; the above box body and cover are carried out under the condition of 130° C.-160° C. heat-sealing to obtain a semi-finished packaging box;
(7) move the above-mentioned semi-finished packaging box into the crystallizer and perform secondary crystallization treatment on the barrier layer of the packaging box to obtain the finished packaging box, where the temperature of the secondary crystallization may be 70° C., and the time of the secondary crystallization may be 10 minutes.

FIG. 2 is a cross-sectional view of the packaging box 10 provided in this example. The inner surface of the box body 11 is adsorbed with the second barrier layer 14, and the surface of the cover body 12 facing the box body 11 is adsorbed with the first barrier layer 13.

### Example 3

The present example provides a method for manufacturing a packaging box, including:
(1) dry PHBH at 55° C. for 8 h, dry PLA at 80° C. for 6 h, and dry PPC at −10° C. for 4 h;
(2) put 70.6 parts by mass of dried PHBH, 5 parts by mass of PLA, and 15 parts by mass of PPC into a mixer, stir at a low speed and while stirring, add 3 parts by mass of talc and 4 parts by mass of modified montmorillonite, 0.6 part by mass of acetylated mono-diglycerol fatty acid ester, 0.5 part by mass of pentaerythritol stearate, 0.3 part by mass of polyethylene wax, 0.3 part by mass of erucamide, 0.5 part by mass of aromatic sulfonate derivative, ethylene-acrylic acid, and 0.2 part by mass of methyl ester-glycidyl methacrylate terpolymer in turn, where the mixture may be stirred at a low speed for 13 min, and then stirred at a high speed for 20 min to obtain a blend;
(3) add the blend to a twin-screw extruder for extrusion and granulation, and dry it at 55° C. for 8 hours to obtain a granulated product, where the extrusion processing temperature of the twin-screw extruder may be 90° C.-160° C., the screw speed may be 150 rpm/min, and the screw length-diameter ratio may be 52;
(4) add the granulated product to the screw extrusion sheet machine, and the first barrier layer is obtained by sheet extrusion molding, where the extrusion molding temperature may be 100° C.-150° C., and the screw length-diameter ratio may be 36;
(5) add the granulated product to an injection molding machine and perform injection molding to obtain a second barrier layer, where the injection molding temperature may be 120° C.-150° C., the screw length-diameter ratio may be 20, and the screw compression ratio may be 3;
(6) blister mold the first barrier layer at 130° C.-160° C. so that it is adhered to the outer surface of the pulp molding substrate, and then blow molding the second barrier layer at 130° C.-160° C., making it adsorbed on the inner surface of the pulp molding base material to obtain the box body of the packaging box; the first barrier layer is slit, and the slitted first barrier layer is hot-pressed at 130° C.-160° C.; make the first barrier layer adhere to the surface of the pulp molding semi-finished pulp board to obtain a cover body; heat-seal the box body and the cover body at 130° C.-160° C. to obtain a semi-finished packaging box;
(7) move the above-mentioned semi-finished packaging box into the crystallizer and perform secondary crystallization treatment on the barrier layer of the packaging box to obtain the finished packaging box, where the temperature of the secondary crystallization may be 55° C., and the time of the secondary crystallization may be 15 min.

FIG. 3 is a cross-sectional view of the packaging box 10 provided in this example. The outer surface of the box body 11 is adhered to the first barrier layer 13, and the inner surface of the box body 11 is adhered to the second barrier layer 14; both surfaces of the cover body 12 are adhered to the first barrier layer 13.

### Comparative Example 1

This comparative example provides a method of manufacturing a packaging box, including:
(1) dry PHBH at 50° C. for 4 h, and dry PLA at 80° C. for 4 h;
(2) put 88.1 parts by mass of the dried PHBH and 11.5 parts by mass of PLA into the mixer, stir at a low speed, add 0.4 part by mass of hexamethylene diisocyanate while stirring, stir at a low speed for 3 minutes, and then stir at a high speed for 10 minutes to obtain a mixture;
(3) add the mixture to a twin-screw extruder for extrusion and granulation, and dry it at 70° C. for 6 hours to obtain a granulated product, where the extrusion processing temperature of the twin-screw extruder may be 90° C.-160° C., the screw speed may be 350 rpm/min, and the screw length-diameter ratio may be 40;
(4) add the granulated product to a screw extruding sheet machine and extruded into a sheet to obtain a barrier layer, where the extrusion molding temperature may be 100° C.-150° C., and the screw length-diameter ratio may be 20;
(5) blister mold the barrier layer at 130° C.-160° C. so that it is adhered to the inner surface of the pulp molding substrate to obtain the box body of the packaging box; the barrier layer is hot-pressed at 130° C.-160° C. to make it adhere to the surface of the pulp molding semi-finished pulp board to obtain a cover; the box body and the cover are heat-sealed at 130° C.-160° C. to obtain a semi-finished package box;
(6) move the above-mentioned semi-finished packing box into the crystallizer and perform secondary crystallization treatment on the barrier layer of the packing box to obtain the finished packing box, where the temperature of the secondary crystallization may be 80° C., and the time of the secondary crystallization may be 5 minutes.

### Comparative Example 2

The difference between this comparative example and Example 1 is that it does not contain a barrier layer.

### Comparative Example 3

The difference between this comparative example and Example 1 is that PLA is used as the barrier layer.

Evaluation of Barrier Layers in Examples 1-3 and Comparative Examples 1-3

Degradation Rate Determination

The degradation rate of the barrier layer is determined according to the controlled composting of GB/T 19277.1 (ISO 14855-1) and ISO 14853, and the measurement results are shown in Table 1.

TABLE 1

| Test | Test | Example | Example | Example | Comparative | Comparative | Comparative |
|---|---|---|---|---|---|---|---|
| Standard | Time | 1 | 2 | 3 | Example 1 | Example 2 | Example 3 |
| ISO | 7 days | 41 | 52 | 32 | 46 | 23 | / |
| 14855 | 14 days | 67 | 78 | 59 | 74 | 38 | / |
| | 28 days | 75 | 85 | 68 | 79 | 61 | / |
| ISO | 3 days | 8 | 17 | 5 | 13 | 25 | 0 |
| 14853 | 5 days | 26 | 36 | 22 | 32 | 45 | 0 |
| | 7 days | 53 | 61 | 49 | 58 | 64 | 0 |
| | 10 days | 70 | 78 | 66 | 75 | 80 | 0 |
| | 15 days | 87 | 94 | 85 | 92 | 97 | 0 |
| | 20 days | 89 | 96 | 86 | 93 | 100 | 0 |

Determination of Water Vapor Transmission

According to the standard of GB/T 1037, the thickness of the barrier layer is cut to about 1 mm, and the water vapor transmission rate (g/m²·day) under the ambient gas of 38° C. and 90% RH is measured. The measurement results are shown in Table 2.

TABLE 2

| | | | | Comparative | Comparative | Comparative |
|---|---|---|---|---|---|---|
| Test Item | Example 1 | Example 2 | Example 3 | Example 1 | Example 2 | Example 3 |
| Water vapor | 4.3 | 3.7 | 0.9 | 9.8 | 1329.2 | 27.8 |
| transmission | | | | | | |
| rate | | | | | | |
| (g/m² · day) | | | | | | |

It can be seen from Table 1 and Table 2 that the composite for manufacturing the barrier layer provided by the present disclosure can not only make the manufactured barrier layer biodegradable, but also have good barrier properties.

In the technical solution of the present disclosure, Polyhydroxyalkanoate is used as the main component, supplemented with other components, with reasonable quantities. The layer has good barrier properties, which can reduce the penetration of fluids and delay the decline of the quality of the packaged product.

Finally, it should be noted that the above examples are only used to illustrate the technical solutions of the present disclosure, but not to limit them; although the present disclosure has been described in detail with reference to the foregoing examples, those of ordinary skill in the art should understand that the technical solutions described in the foregoing examples can still be modified, or some or all of the technical features thereof can be equivalently replaced; and these modifications or replacements do not make the essence of the corresponding technical solutions deviate from the scope of the technical solutions of the examples of the present disclosure.

What is claimed is:

1. A composite for manufacturing a barrier layer, comprising:
Polyhydroxyalkanoate, 70 to 96 parts by mass, wherein a total mass of the composite is 100 parts by mass;
polylactic acid, 1 to 15 parts by mass;
modified layered silicate, 1 to 5 parts by mass;
polyalkylene carbonate, 1 to 20 parts by mass; and
auxiliary agent, 1.3 to 12 parts by mass.

2. The composite of claim 1, wherein the Polyhydroxyalkanoate comprises copolymers of 3-hydroxybutyric acid and 3-hydroxyhexanoic acid.

3. The composite of claim 1, wherein the modified layered silicates comprise organic modified layered silicates, and an average interlayer distance on the (001) plane of the organic modified layered silicates is equal to or greater than 3 nm.

4. The composite of claim 1, wherein the polyalkylene carbonate comprises end-capped polypropylene carbonate.

5. The composite of claim 1, wherein the auxiliary agent comprises:
inorganic nucleating agent, 1 to 5 parts by mass;
organic nucleating agent, 0.1 to 2 parts by mass;
compatibilizer, 0.1 to 2 parts by mass; and
lubricant, 0.1 to 3 parts by mass.

6. The composite of claim 5, wherein the inorganic nucleating agent comprises talc powder, an average particle size D₅₀ of the talc powder is within 0.5-1.5 μm, and an average particle size D₉₈ of the talc powder is less than or equal to 6 μm.

7. The composite of claim 5, wherein the organic nucleating agent comprises at least one of followings:
hydroxyapatite, sodium lignosulfonate, zinc phenylphosphonate, aromatic sulfonate derivatives, rare earth beta crystal nucleating agents, aramid beta crystal nucleating agents, sebacic acid dibenzoyl hydrazide, or polyamide compounds.

8. The composite of claim 5, wherein the compatibilizer comprises at least one of followings:
ethylene-methyl acrylate-glycidyl methacrylate terpolymer, hexamethylene diisocyanate, diphenylmethane diisocyanate, 2,4-toluene diisocyanate, 2,2′-Bis(2-oxazoline), 1,3-phenyl-bis(2-oxazoline), dicumyl peroxide, epoxy chain extender, or styrene-maleic anhydride random copolymer.

9. The composite of claim 5, wherein the lubricant comprises at least one of followings:
acetylated mono-diglycerol fatty acid ester, ethylene bis-stearic acid amide, pentaerythritol stearate, erucic acid amide, oleic acid amide, stearic acid, polyethylene wax, zinc stearate, or ethylene acrylic acid copolymer.

10. A barrier layer manufactured using a composite, comprising:
Polyhydroxyalkanoate, 70 to 96 parts by mass, wherein a total mass of the composite is 100 parts by mass;
polylactic acid, 1 to 15 parts by mass;
modified layered silicate, 1 to 5 parts by mass;
polyalkylene carbonate, 1 to 20 parts by mass; and
auxiliary agent, 1.3 to 12 parts by mass.

11. The barrier layer of claim 10, wherein the Polyhydroxyalkanoate comprises copolymers of 3-hydroxybutyric acid and 3-hydroxyhexanoic acid.

12. The barrier layer of claim 10, wherein the modified layered silicates comprise organic modified layered silicates, and an average interlayer distance on the (001) plane of the organic modified layered silicates is equal to or greater than 3 nm.

13. The barrier layer of claim 10, wherein the polyalkylene carbonate comprises end-capped polypropylene carbonate.

14. The barrier layer of claim 10, wherein the auxiliary agent comprises:
inorganic nucleating agent, 1 to 5 parts by mass;
organic nucleating agent, 0.1 to 2 parts by mass;
compatibilizer, 0.1 to 2 parts by mass; and
lubricant, 0.1 to 3 parts by mass.

15. The barrier layer of claim 14, wherein the inorganic nucleating agent comprises talc powder, an average particle size D₅₀ of the talc powder is within 0.5-1.5 μm, and an average particle size D₉₈ of the talc powder is less than or equal to 6 μm,
wherein the organic nucleating agent comprises at least one of followings: hydroxyapatite, sodium lignosulfonate, zinc phenylphosphonate, aromatic sulfonate derivatives, rare earth beta crystal nucleating agents, aramid beta crystal nucleating agents, sebacic acid dibenzoyl hydrazide, or polyamide compounds,
wherein the compatibilizer comprises at least one of followings: ethylene-methyl acrylate-glycidyl methacrylate terpolymer, hexamethylene diisocyanate, diphenylmethane diisocyanate, 2,4-toluene diisocyanate, 2,2′-Bis(2-oxazoline), 1,3-phenyl-bis(2-oxazoline), dicumyl peroxide, epoxy chain extender, or styrene-maleic anhydride random copolymer, and
wherein the lubricant comprises at least one of followings: acetylated mono-diglycerol fatty acid ester, ethylene bis-stearic acid amide, pentaerythritol stearate, erucic acid amide, oleic acid amide, stearic acid, polyethylene wax, zinc stearate, or ethylene acrylic acid copolymer.

16. The barrier layer as in claim 10, wherein a water vapor transmission rate of the barrier layer is within 0.9 g/m²·day-4.3 g/m²·day.

17. A method of manufacturing a barrier layer, comprising:
blending and granulating Polyhydroxyalkanoate, polylactic acid, modified layered silicate, polyalkylene carbonate, and auxiliary agent to obtain a granulated product; and
molding the granulated product by extrusion or injection to obtain the barrier layer.

18. The method of claim 17, wherein the barrier layer is manufactured using a composite comprising:
Polyhydroxyalkanoate, 70 to 96 parts by mass, wherein a total mass of the composite is 100 parts by mass;
polylactic acid, 1 to 15 parts by mass;
modified layered silicate, 1 to 5 parts by mass;
polyalkylene carbonate, 1 to 20 parts by mass; and
auxiliary agent, 1.3 to 12 parts by mass.

19. A packaging material, comprising:
a substrate; and
a barrier layer according to claim 10, wherein the barrier layer is disposed on at least one surface of the substrate.

20. The packaging material of claim 19, wherein a water vapor transmission rate of the barrier layer is within 0.9 g/m²·day-4.3 g/m²·day.
